(19) United States
(12) Patent Application Publication
(10) Pub. No.: US 2025/0376020 A1
(43) Pub. Date: Dec. 11, 2025

(54) FLUID TRANSFER ASSEMBLY AND METHOD OF USING THE SAME

(71) Applicant: NABORS ENERGY TRANSITION SOLUTIONS LLC, Houston, TX (US)

(72) Inventors: Zachary BAKER, Cleveland, TX (US); Paul YOLLIN, Tomball, TX (US)

(21) Appl. No.: 19/181,662

(22) Filed: Apr. 17, 2025

Related U.S. Application Data
(60) Provisional application No. 63/635,266, filed on Apr. 17, 2024.

(51) Int. Cl. B60K 15/01

(52) U.S. Cl. CPC B60K 15/013; B60K 2015/016

(57) ABSTRACT

The present application is directed to a fluid transfer assembly including: a fluid line including a hydrogen-based fluid stream; and a Venturi lubricant injector fluidly connected to the fluid line and adapted to inject lubricant into the hydrogen-based fluid stream within the fluid line.

### CROSS-REFERENCE TO RELATED APPLICATION(S)

This application claims priority under 35 U.S.C. § 119 (e) to U.S. Provisional Patent Application No. 63/635,266, entitled “FLUID TRANSFER ASSEMBLY AND METHOD OF USING THE SAME,” by Zachary BAKER et al., filed Apr. 17, 2024, which is assigned to the current assignee hereof and is incorporated herein by reference in its entirety.

### FIELD OF THE DISCLOSURE

The present disclosure relates to fluid transfer assemblies and, more particularly, to fluid transfer assemblies used in power trains and other applications.

### RELATED ART

Fluid transfer assemblies are generally known to transfer fluids for use in many applications such as, but not limited to, power trains for electric vehicles or hybrid vehicles. A recent development in energy sources has been the use of hydrogen as a promising non-polluting fossil fuel alternative for similar applications. Hydrogen can be injected with oxygen via combustion or through fuel cell mediated redox reactions to produce heat, electrical power and/or to power vehicles. The product of this reaction, water, is non-polluting and can be recycled to regenerate hydrogen and oxygen. However, hydrogen injection is in need of improvement as it can be injected unevenly and without proper lubricant dosing, which provides for less efficient operation of the power train. Current systems use a high-pressure pump and an injector for lubricant dosing, which is power intensive and requires a large footprint on the assembly.

Therefore, improvements in fluid transfer assemblies are needed, which allow for improved performance in hydrogen injection for applications such as, but not limited to, power trains.

### BRIEF DESCRIPTION OF THE DRAWINGS

Embodiments are illustrated by way of example and are not limited in the accompanying figures.

FIG. 1A illustrates a schematic view of a fluid transfer assembly according to a number of embodiments of the present disclosure.

FIG. 1B illustrates a side view of a fluid transfer assembly of the dotted line 110 of FIG. 1A according to a number of embodiments of the present disclosure.

FIG. 2A illustrates a disassembled view of a Venturi lubricant injector according to a number of embodiments of the present disclosure.

FIG. 2B illustrates a cross-sectional view of a Venturi lubricant injector according to a number of embodiments of the present disclosure.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the fluid transfer assembly arts.

The following disclosure describes fluid transfer assemblies for improved hydrogen injectors. The concepts are better understood in view of the embodiments described below that illustrate and do not limit the scope of the present invention.

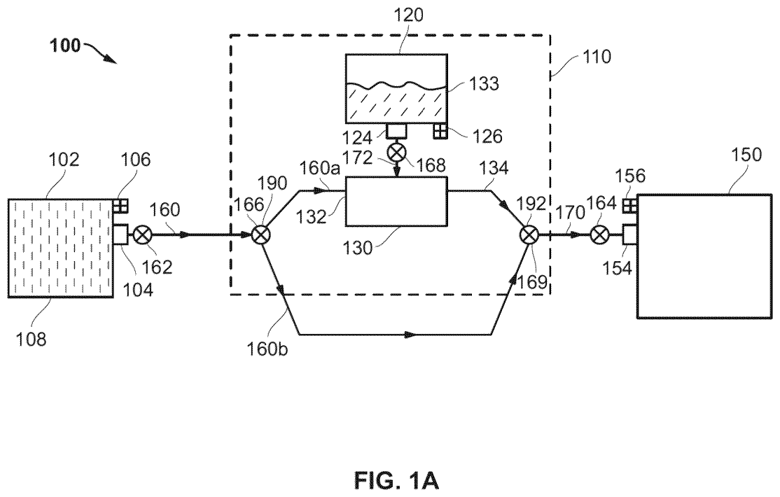

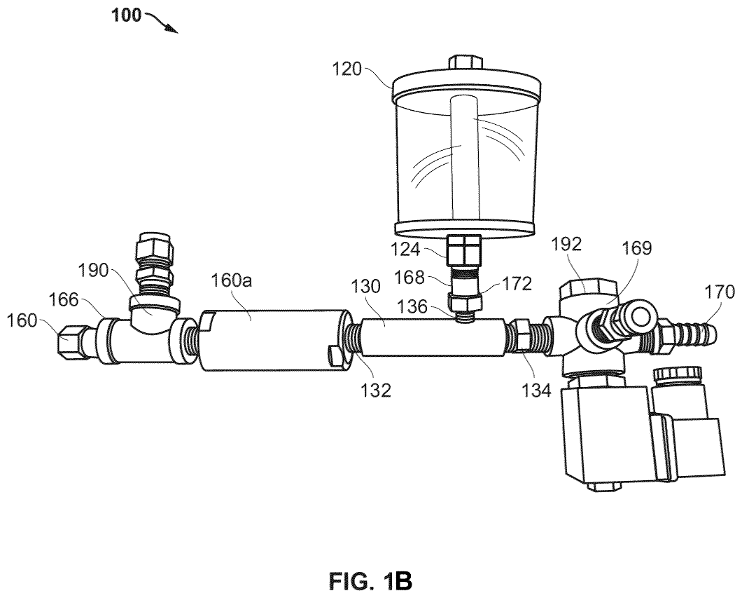

For purposes of illustration, FIG. 1A illustrates a schematic view of a fluid transfer assembly 100 according to a number of embodiments of the present disclosure. For purposes of illustration, FIG. 1B illustrates a side view of a fluid transfer assembly 100 of the dotted line 110 of FIG. 1A according to a number of embodiments of the present disclosure. As best illustrated in FIG. 1A, the fluid transfer assembly 100 may include a source reservoir 102 (also referred to herein as vessel 102). In certain embodiments, the vessel 102 may be a suitable vessel that is configured for hydrogen storage for a fluid 108. In certain embodiments, the vessel 102 may be pressurized. In certain embodiments, the vessel 102 may prevent backflow. In a number of embodiments, the vessel 102 may include a vent, a level sensor, or a bubble detector (not shown).

In a number of embodiments, the fluid 108 may be gaseous or liquid hydrogen. The fluid 108 may be at least 20% hydrogen, such as at least 30% hydrogen, such as at least 40% hydrogen, such as at least 50% hydrogen, such as at least 60% hydrogen, such as at least 70% hydrogen, such as at least 80% hydrogen, such as at least 90% hydrogen, such as at least 95% hydrogen, or even such as at least 99% hydrogen. It will be appreciated that the hydrogen % within the fluid 108 may be any value between, and including, any of the minimum and maximum values noted above. It will be further appreciated that the hydrogen % within the fluid 108 may be within a range between, and including, any of the minimum and maximum values noted above.

In a number of embodiments, as shown best in FIG. 1A, the vessel 102 may include a port 104 adapted to allow fluid 108 to exit the vessel 102. In an embodiment, an air filter 106 may be associated with the port 104 or vessel 102. In an embodiment, the air filter 106 may be located on the port 104 or elsewhere on the vessel 102. Further, in a number of embodiments, the port 104 may include at least one valve 162. The at least one valve 162 may include a gate valve, a check valve, or a butterfly valve. It is contemplated that the at least one valve 162 can be manually controlled or controlled automatically via an actuator. In a number of embodiments, the actuator may include a solenoid to selectively move fluid through selective actuation. The solenoid may allow control of the valve by a user or by an automated system (such as an electronic monitoring system). In an embodiment, the at least one valve 162 may be positioned to prevent fluid 108 from being inadvertently pushed back into the vessel 102.

As illustrated best in FIG. 1A, the port 104 may feed fluid 108 into an input line 160 which (through valve 162) permits only unidirectional flow of fluid 108 as indicated by the arrows. In an embodiment, the input line 160, other lines herein, and/or various components of the fluid transfer assembly 100, may be fluidly interconnected through tubing. As used herein, the term “tubing” may refer to at least a portion of one or more of the lines of the fluid transfer assembly 100 adapted to move fluid. The tubing may be weldable and are generalized to include any length and include any applicable connections thereof. Further, the tubing may be generalized to include any fittings between neighboring tubing portions. In a number of embodiments, the tubing may be a chemically inert material allowing movement of fluid 108 therein. In a number of embodiments, the tubing may be a metal. In a number of embodiments, the tubing may include a polymer. In a number of embodiments, the tubing may include a ceramic.

In a number of embodiments, the tubing of the fluid input line 160 or other tubing recited herein may have a length of at least 1 in, at least 2 in, at least 5 in, at least 10 in, at least 25 in, at least 50 in, at least 100 in, or at least 500 in. In a number of embodiments, the tubing of the fluid input line 160 or other tubing recited herein may have a length of no greater than 1000 in, no greater than 500 in, no greater than 250 in, no greater than 100 in, no greater than 50 in, or no greater than 25 in. It will be appreciated that the tubing of the fluid input line 160 or other tubing recited herein may have a length at any value between, and including, any of the minimum and maximum values noted above. It will be further appreciated that the tubing of the fluid input line 160 or other tubing recited herein may have a length within a range between, and including, any of the minimum and maximum values noted above.

In a number of embodiments, the tubing of the fluid input line 160 or other tubing recited herein may have a diameter of at least 0.1 in, at least 0.2 in, at least 0.25 in, at least 0.5 in, at least 1 in, or at least 5 in. In a number of embodiments, the tubing of the fluid input line 160 or other tubing recited herein may have a diameter of no greater than 10 in, no greater than 5 in, no greater than 2.5 in, no greater than 1 in, no greater than 0.5 in, or no greater than 0.25 in. It will be appreciated that the tubing of the fluid input line 160 or other tubing recited herein may have a diameter at any value between, and including, any of the minimum and maximum values noted above. It will be further appreciated that the tubing of the fluid input line 160 or other tubing recited herein may have a diameter within a range between, and including, any of the minimum and maximum values noted above.

As illustrated in FIG. 1A, in a number of embodiments, the fluid transfer assembly 100 may include an output reservoir 150 operably and/or fluidly connected to the vessel 102 as described in further detail below. As illustrated in FIG. 1A, the output reservoir 150 may house a fluid 108 from the source vessel 102 through operation of the fluid transfer assembly 100 and/or fluid transfer assembly 110. In an embodiment, the output reservoir 150 may include a powertrain component for a vehicle such as, but not limited to, a fuel cell or an internal combustion engine for which the fluid may be used in operation.

In a number of embodiments, as shown best in FIG. 1A, the output reservoir 150 may include a port 154 adapted to allow fluid 108 to enter the output reservoir 150. In an embodiment, an air filter 156 may be associated with the port 154 or output reservoir 150. In an embodiment, the air filter 156 may be located on the port 154 or elsewhere on the output reservoir 150. Further, in a number of embodiments, the port 154 may include at least one valve 164. The at least one valve 164 may include a gate valve, a check valve, or a butterfly valve. It is contemplated that the at least one valve 164 can be manually controlled or controlled automatically via an actuator. In a number of embodiments, the actuator may include a solenoid to selectively move fluid through selective actuation. The solenoid may allow control of the valve by a user or by an automated system (such as an electronic monitoring system). In an embodiment, the at least one valve 164 may be positioned to prevent fluid 108 from being inadvertently pushed back into the remaining fluid transfer assembly 100.

As illustrated best in FIG. 1A, the port 154 may accept fluid 108 from an output line 170 (described in further detail below) which (through valve 164) permits only unidirectional flow of fluid 108 as indicated by the arrows. In an embodiment, the output line 170, and various components of the fluid transfer assembly 100, may be fluidly interconnected through tubing as described herein.

As illustrated, the fluid transfer assembly 100 may include a partial fluid transfer assembly (indicated by dotted line 110). In an embodiment, the fluid transfer assembly 100 may take input from the input line 160 through at least one valve 166. The at least one valve 166 may include a gate valve, a check valve, or a butterfly valve. It is contemplated that the at least one valve 166 can be manually controlled or controlled automatically via an actuator. In a number of embodiments, the actuator may include a solenoid to selectively move fluid through selective actuation. The solenoid may allow control of the valve by a user or by an automated system (such as an electronic monitoring system). In an embodiment, the at least one valve 166 may be positioned to prevent fluid 108 from being inadvertently pushed back into the vessel 102.

As illustrated in FIGS. 1A-1B, in a number of embodiments, the fluid transfer assembly 100 may include a split 190 in the input line 160 driven by the at least one valve 166. In a number of embodiments, the split 190 may divert fluid 108 into either a first input fluid line section 160a or a second input fluid line section 160b.

The first input fluid line section 160a may feed fluid 108 into a Venturi lubricant injector 130 described further below. The fluid 108 may then be injected with lubricant 133. In a number of embodiments, the lubricant 133 may include at least one of a grease including at least one of lithium soap, lithium disulfide, graphite, mineral or vegetable oil, silicone grease, fluorether-based grease, apiezon, food-grade grease, petrochemical grease, or may be a different type. In at least one embodiment, the lubricant may include an oil including at least one of a Group I-GroupIII+oil, paraffinic oil, naphthenic oil, aromatic oil, biolubricant, castor oil, canola oil, palm oil, sunflower seed oil, rapeseed oil, tall oil, lanolin, synthetic oil, polyalpha-olefin, synthetic ester, polyalkylene glycol, phosphate ester, alkylated naphthalene, silicate ester, ionic fluid, multiply alkylated cyclopentane, petrochemical based oil, combinations thereof, or may be a different type. In at least one embodiment, the lubricant may include a solid based lubricant including at least one of lithium soap, graphite, boron nitride, molybdenum disulfide, tungsten disulfide, combinations thereof, or may be a different type.

The lubricant 133 may be housed in a lubricant reservoir 120. In certain embodiments, the lubricant reservoir 120 may be a suitable vessel that is configured for storing a lubricant 133. In certain embodiments, the lubricant reservoir 120 may be pressurized. In certain embodiments, the lubricant reservoir 120 may prevent backflow. In a number of embodiments, the lubricant reservoir 120 may include a vent or air filter, a level sensor, or a bubble detector (not shown). In a number of embodiments, the vent or air filter may expose lubricant to the surrounding atmosphere. In a number of embodiments, as shown best in FIG. 1A, the lubricant reservoir 120 may include a port 124 adapted to allow lubricant 133 to exit the lubricant reservoir 120 into a lubricant input line 171 to fluidly connect the lubricant reservoir 120 to the Venturi lubricant injector 130. In an embodiment, an air filter or vent 126 may be associated with the port 124 or lubricant reservoir 120. In an embodiment, the air filter or vent 126 may be located on the port 124 or elsewhere on the lubricant reservoir 120. Further, in a number of embodiments, the port 124 may include at least one valve 168. The at least one valve 168 may include a gate valve, a check valve, or a butterfly valve. It is contemplated that the at least one valve 168 can be manually controlled or controlled automatically via an actuator. In a number of embodiments, the actuator may include a solenoid to selectively move fluid through selective actuation. The solenoid may allow control of the valve by a user or by an automated system (such as an electronic monitoring system). In an embodiment, the at least one valve 168 may be positioned to prevent lubricant 133 from being inadvertently pushed back into the lubricant reservoir 120.

In a number of embodiments, the lubricant reservoir 120 may have a volume of at least 1 oz, at least 2 oz, at least 5 oz, at least 10 oz, at least 25 oz, at least 50 oz, at least 100 oz, at least 150 oz, at least 250 oz, or at least 500 oz. In a number of embodiments, the lubricant reservoir 120 may have a volume of no greater than 1000 oz, no greater than 500 oz, no greater than 250 oz, no greater than 100 oz, no greater than 50 oz, or no greater than 25 oz. It will be appreciated that the lubricant reservoir 120 may have a volume at any value between, and including, any of the minimum and maximum values noted above. It will be further appreciated that the lubricant reservoir 120 may have a volume within a range between, and including, any of the minimum and maximum values noted above.

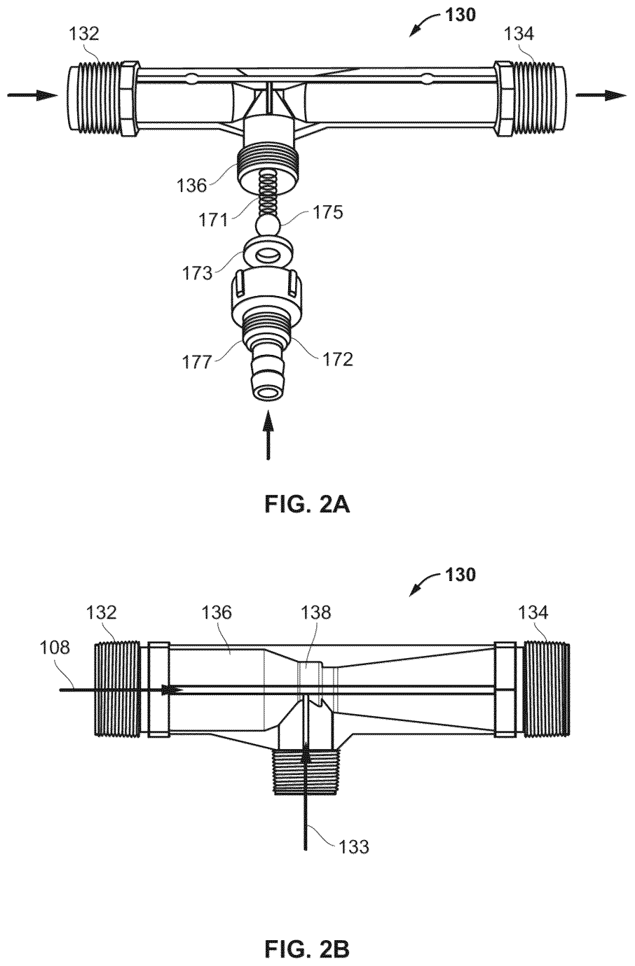

In a number of embodiments, as stated above, the lubricant injector 130 may input fluid 108 from the first input fluid line section 160a and lubricant 133 from the lubricant input line 172 and mix them in a Venturi lubricant injector 130. For purposes of illustration, FIG. 2A illustrates a disassembled view of a Venturi lubricant injector according to a number of embodiments of the present disclosure. For purposes of illustration, FIG. 2B illustrates a cross-sectional view of a Venturi lubricant injector according to a number of embodiments of the present disclosure. As illustrated in FIGS. 2A-2B, in a number of embodiments, the lubricant injector 130 may include a fluid inlet 132 and a fluid outlet 134 for entry and exit of fluid 108 through the lubricant injector 130. Further, as illustrated in FIGS. 2A-2B, in a number of embodiments, the lubricant injector 130 may include a lubricant inlet 136 fluidly connected with the lubricant input line 172. As shown, the lubricant input line 172 may include additional components including, but not limited to, a spring 171, a gasket 173, a port ball 175, and a port cap connector 177 for connecting to tubing of the lubricant input line 172 and the lubricant inlet 136. The port cap connector 177 may include threads for the mechanical attachment of neighboring components as shown.

As shown best in FIG. 2B, the lubricant injector 130 may be shaped like a Venturi such that suction draws lubricant 133 from the lubricant input line 172 into the lubricant injector and mix with the fluid 108. Venturi chemistry, structure, and function is contemplated as part of the lubricant injector 130 herein. As shown, the lubricant injector 130 may have a narrowed passage or constricted section of the fluid 108, causing a pressure differential that draws lubricant 133 from the lubricant reservoir 120 into the fluid 108 stream through the lubricant injector 130. In this way, the Venturi lubricant injector 130 may include a first cross-section 136 and a second cross-section 138, where the second cross-section 138 has a smaller diameter than the first cross-section 136.

In a number of embodiments, the fluid 108 may have flow through the lubricant injector at a flowrate of at least 5 g hydrogen/hr, such as at least 10 g hydrogen/hr, such as at least 15 g hydrogen/hr, such as at least 25 g hydrogen/hr, such as at least 50 g hydrogen/hr, such as at least 100 g hydrogen/hr, such as at least 150 g hydrogen/hr, such as at least 200 g hydrogen/hr, such as at least 250 g hydrogen/hr, such as at least 500 g hydrogen/hr, such as at least 750 g hydrogen/hr, such as at least 1000 g hydrogen/hr, such as at least 1500 g hydrogen/hr, such as at least 2500 g hydrogen/hr, or such as at least 5000 g hydrogen/hr. It will be appreciated that the fluid 108 may have flow through the lubricant injector at a flowrate at any value between, and including, any of the minimum and maximum values noted above. It will be further appreciated that the fluid 108 may have flow through the lubricant injector at a flowrate within a range between, and including, any of the minimum and maximum values noted above.

In a number of embodiments, the fluid 108 may have flow through the lubricant injector at a flowrate of at least 60.24 L hydrogen/hr as measured at standard atmospheric pressure and temperature, such as at least 120.48 L hydrogen/hr, such as at least 180.72 L hydrogen/hr, such as at least 301.20 L hydrogen/hr, such as at least 602.41 L hydrogen/hr, such as at least 1204.82 L hydrogen/hr, such as at least 1807.23 L hydrogen/hr, such as at least 2409.64 L hydrogen/hr, such as at least 3012.05 L hydrogen/hr, such as at least 6024.10 L hydrogen/hr, such as at least 9036.14 L hydrogen/hr, such as at least 12048.19 L hydrogen/hr, such as at least 18072.29 L hydrogen/hr, such as at least 30120.48 L hydrogen/hr, or such as at least 60240.96 L hydrogen/hr. It will be appreciated that the fluid 108 may have flow through the lubricant injector at a flowrate at any value between, and including, any of the minimum and maximum values noted above. It will be further appreciated that the fluid 108 may have flow through the lubricant injector at a flowrate within a range between, and including, any of the minimum and maximum values noted above.

In a number of embodiments, the lubricant injector 130 may inject lubricant 133 into the fluid 108 at a flowrate of at least 0.1 mL lubricant/hr, such as at least 0.2 mL lubricant/hr, such as at least 0.5 mL lubricant/hr, such as at least 1 mL lubricant/hr, such as at least 5 mL lubricant/hr, such as at least 10 mL lubricant/hr, such as at least 15 mL lubricant/hr, such as at least 25 mL lubricant/hr, such as at least 50 mL lubricant/hr, such as at least 100 mL lubricant/hr, such as at least 150 mL lubricant/hr, such as at least 200 mL lubricant/hr, such as at least 250 mL lubricant/hr, such as at least 500 mL lubricant/hr, or such as at least 1000 mL lubricant/hr. It will be appreciated that the lubricant injector 130 may inject lubricant 133 into the fluid 108 at a flowrate at any value between, and including, any of the minimum and maximum values noted above. It will be further appreciated that the lubricant injector 130 may inject lubricant 133 into the fluid 108 at a flowrate within a range between, and including, any of the minimum and maximum values noted above.

In a number of embodiments, the lubricant injector 130 may have a volume of at least 1 in³, at least 2 in³, at least 5 in³, at least 10 in³, at least 20 in³, at least 25 in³, at least 50 in³, at least 100 in³, at least 250 in³, or at least 500 in³. In a number of embodiments, the lubricant injector 130 may have a volume of no greater than 1000 in³, no greater than 500 in³, no greater than 100 in³, no greater than 50 in³, no greater than 25 in³, or no greater than 10 in³. It will be appreciated that the lubricant injector 130 may have a volume at any value between, and including, any of the minimum and maximum values noted above. It will be further appreciated that the lubricant injector 130 may have a volume within a range between, and including, any of the minimum and maximum values noted above.

In a number of embodiments, the lubricant injector 130 may maintain an internal pressure of at least 10 psi, at least 15 psi, at least 25 psi, at least 50 psi, at least 100 psi, at least 150 psi, at least 200 psi, at least 250 psi, or at least 500 psi. In a number of embodiments, the lubricant injector 130 may maintain an internal pressure of no greater than 1000 psi, no greater than 500 psi, no greater than 250 psi, no greater than 200 psi, no greater than 150 psi, or no greater than 100 psi. It will be appreciated that the lubricant injector 130 may maintain an internal pressure at any value between, and including, any of the minimum and maximum values noted above. It will be further appreciated that the lubricant injector 130 may maintain an internal pressure within a range between, and including, any of the minimum and maximum values noted above.

In a number of embodiments, the lubricant injector 130 may have a length of at least 1 in, at least 2 in, at least 5 in, at least 10 in, at least 25 in, at least 50 in, at least 100 in, or at least 500 in. In a number of embodiments, the lubricant injector 130 may have a length of no greater than 1000 in, no greater than 500 in, no greater than 250 in, no greater than 100 in, no greater than 50 in, or no greater than 25 in. It will be appreciated that the lubricant injector 130 may have a length at any value between, and including, any of the minimum and maximum values noted above. It will be further appreciated that the lubricant injector 130 may have a length within a range between, and including, any of the minimum and maximum values noted above.

In a number of embodiments, the lubricant injector 130 may have a diameter of a diameter of at least 0.1 in, at least 0.2 in, at least 0.5 in, at least 0.25 in, at least 1 in, or at least 5 in. In a number of embodiments, the lubricant injector 130 may have a diameter of no greater than 10 in, no greater than 5 in, no greater than 2.5 in, no greater than 1 in, no greater than 0.5 in, or no greater than 0.25 in. It will be appreciated that the lubricant injector 130 may have a diameter at any value between, and including, any of the minimum and maximum values noted above. It will be further appreciated that the lubricant injector 130 may have a diameter within a range between, and including, any of the minimum and maximum values noted above.

In a number of embodiments, the lubricant injector 130 may have a length:diameter ratio of at least 10:1, at least 25:1, at least 50:1, at least 75:1, or at least 100:1. In a number of embodiments, the lubricant injector 130 may have a length:diameter ratio of no greater than 10000:1, no greater than 5000:1, no greater than 1000:1, or no greater than 500:1. It will be appreciated that the lubricant injector 130 may have a diameter at any value between, and including, any of the minimum and maximum values noted above. It will be further appreciated that the lubricant injector 130 may have a diameter within a range between, and including, any of the minimum and maximum values noted above.

Referring back to FIGS. 1A-1B, in a number of embodiments, the fluid transfer assembly 100 may include a joint 192 to re-join the first input fluid line section 160a (after it exits the lubricant injector 130) and the second input fluid line section 160b. Further, in a number of embodiments, the joint 192 may include at least one valve 169. The at least one valve 169 may include a gate valve, a check valve, or a butterfly valve. It is contemplated that the at least one valve 169 can be manually controlled or controlled automatically via an actuator. In a number of embodiments, the actuator may include a solenoid to selectively move fluid through selective actuation. The solenoid may allow control of the valve by a user or by an automated system (such as an electronic monitoring system). In an embodiment, the at least one valve 169 may be positioned to prevent fluid 108 and/or lubricant 133 from being inadvertently pushed back into the remaining fluid transfer assembly 100. The output line 170 may accept lubricant and fluid from the joint 192 and feed lubricant and fluid into the output reservoir 150 as described above. As described the amount of fluid 108 moved between components may be verified by automated optical sensing methods, mechanical stops, by markings on the syringe, and/or by weight. Further, purging of the fluid transfer assembly 110 is contemplated herein.

In particular embodiments, at least one of the components of the fluid transfer assembly (including at least one of the components of the source reservoir, input line, output line, tubing, lubricant injector, lubricant reservoir, output reservoir) can be formed of a material including, metal, plastic, glass, ceramic, or combinations thereof.

In a number of embodiments, at least one of the components of the fluid transfer assembly (including at least one of the components of the source reservoir, input line, output line, tubing, lubricant injector, lubricant reservoir, output reservoir, valve) can be a metal. In a number of embodiments, the metal can include at least one of copper, nickel, aluminum, silicone, magnesium, lithium, sodium, iron, cobalt, manganese, titanium, tantalum, tungsten, calcium, potassium, combinations thereof, or alloys thereof. In an embodiment, the metal can include steel. The steel can include stainless steel, such as austenitic stainless steel. Moreover, the steel can include stainless steel including chrome, nickel, or a combination thereof. For example, the steel can include X10CrNi18-8 stainless steel (EN 1.4310; AISI 302).

In a number of embodiments, at least one of the components of the fluid transfer assembly (including at least one of the components of the source reservoir, input line, output line, tubing, lubricant injector, lubricant reservoir, output reservoir, valve) can be a ceramic. In a number of embodiments, the ceramic may include at least one of aluminum oxide, aluminum nitride, boron nitride, copper oxide, silicon nitride, silicon oxide, zirconium oxide, zirconium dioxide, or a combination thereof. In a number of embodiments, the ceramic may include at least one of carbon-based nanomaterials (e.g., graphene, nanoplatelets, graphite) or Silicon-based Materials (e.g., Si, SiO, SiO2).

In a number of embodiments, at least one of the components of the fluid transfer assembly (including at least one of the components of the source reservoir, input line, output line, tubing, lubricant injector, lubricant reservoir, output reservoir, valve) can be a polymer. In a number of embodiments, the polymer can include at least one of a thermoplastic elastomeric hydrocarbon block copolymer, a polyether-ester block co-polymer, a thermoplastic polyamide elastomer, a thermoplastic polyurethane elastomer, a thermoplastic polyolefin elastomer, a thermoplastic vulcanizate, an olefin-based co-polymer, a styrene based block co-polymer, an olefin-based ter-polymer, a polyolefin plastomer, or combinations thereof. In a number of embodiments, the polymer can include at least one of ethylene-tetrafluoroethylene, tetrafluoro-ethylene-perfluoro (methyl vinyl ether), polyvinylidene fluoride, ethylene-chlorotrifluoroethylene, polyimide, polyamidimide, polyphenylene sulfide, polyethersulfone, polyphenylene sulfone, liquid crystal polymers, polyetherketone, polyether ether ketones, aromatic polyesters (Ekonol®), polyesters of polyether-ether-ketone (PEEK), polyamide, polyethylene/UHMPE, polypropylene, polyethylene, polystyrene, styrene butadiene copolymers, polyesters, polycarbonate, polyacrylonitriles, polyamides, styrenic block copolymers, ethylene vinyl alcohol copolymers, ethylene vinyl acetate copolymers, polyesters grafted with maleic anhydride, poly-vinylidene chloride, aliphatic polyketone, ethylene methyl acrylate copolymer, ethylene-norbonene copolymers, polymethylpentene and ethylene acrylic acid copolymer, and mixtures, copolymers and any combination thereof. In an embodiment, the polymer can include at least one of polytetrafluoroethylene (PTFE), modified polytetrafluoroethylene (mPTFE), ethylene-tetrafluoroethylene (ETFE), perfluoroalkoxyethylene (PFA), tetrafluoroethylene-hexafluoropropylene (FEP), tetrafluoro-ethylene-perfluoro (methyl vinyl ether) (MFA), polyvinylidene fluoride (PVDF), ethylene-chlorotrifluoroethylene (ECTFE), polyimide (PI), polyamidimide (PAI), polyphenylene sulfide (PPS), polyethersulofone (PES), polyphenylene sulfone (PPSO2), liquid crystal polymers (LCP), polyetherketone (PEK), polyether ether ketones (PEEK), aromatic polyesters (e.g., Ekonol®), of polyether-ether-ketone (PEEK), polyetherketone (PEK), liquid crystal polymer (LCP), polyamide (PA), polyoxymethylene (POM), polyethylene (PE) (including HMWPE, UHMPE, and LMWPE), polypropylene (PP), polystyrene, styrene butadiene copolymers, polyesters, polycarbonate, polyacrylonitriles, polyamides, styrenic block copolymers, ethylene vinyl alcohol copolymers, ethylene vinyl acetate copolymers, polyesters grafted with maleic anhydride, poly-vinylidene chloride, aliphatic polyketone, liquid crystalline polymers, ethylene methyl acrylate copolymer, ethylene-norbonene copolymers, polymethylpentene and ethylene acrylic acid copolymer, and mixtures, copolymers and any combination thereof.

Further, in an embodiment, at least one of the components of the fluid transfer assembly can include one or more additives. For example, the one or more additives can include a plasticizer, a catalyst, a silicone modifier, a silicon component, a stabilizer, a curing agent, a lubricant, a colorant, a filler, a blowing agent, another polymer as a minor component, or a combination thereof.

In an embodiment, at least one of the components of the fluid transfer assembly can be formed as a single piece or may be formed as multiple pieces. In an embodiment, at least one of the components of the fluid transfer assembly can be a molded component. In an embodiment, at least one of the components of the fluid transfer assembly can be formed through extrusion, metalworking, molding, or other methods known in the art.

In a number of embodiments, referring back to FIGS. 1A-1B, a method of modifying fluid is shown. The method may include providing a fluid line 160a, flowing hydrogen-based fluid 108 through the fluid line 160a, providing a Venturi lubricant injector 130 including lubricant 133 and fluidly connected to the fluid line 160a, and injecting the lubricant 133 from the Venturi lubricant injector into the hydrogen-based fluid 108 within the fluid line 160a.

Use of the fluid transfer assembly may provide increased benefits in several applications in fields such as, but not limited to industrial, medical, health care, biopharmaceutical, pharmaceutical, drinking water, food & beverage, laboratory, dairy, vehicular, fuel cell, or other types of applications. Notably, the use of the fluid transfer assembly may provide improved performance for hydrogen injection for applications such as, but not limited to, power trains. Further, the fluid transfer assembly may provide less power, less energy, and less footprint on hydrogen injection through adequate lubricant dosing. Lastly, the fluid transfer assembly may carefully control the amount of lubricant added to the fluid for use in several applications without the need for high pressure pumps or secondary injectors, minimizing the energy required and lengthening operational lifetime of the fluid transfer assembly.

Many different aspects and embodiments are possible. Some of those aspects and embodiments are described below. After reading this specification, skilled artisans will appreciate that those aspects and embodiments are only illustrative and do not limit the scope of the present invention.
Embodiment 1: A fluid transfer assembly comprising: a fluid line comprising a hydrogen-based fluid stream; and a Venturi lubricant injector fluidly connected to the fluid line and adapted to inject lubricant into the hydrogen-based fluid stream within the fluid line.
Embodiment 2: A method of modifying fluid comprising: providing a fluid line; flowing hydrogen-based fluid through the fluid line; providing a Venturi lubricant injector comprising a lubricant and fluidly connected to the fluid line; injecting the lubricant from the Venturi lubricant injector into the hydrogen-based fluid stream within the fluid line.
Embodiment 3: The fluid transfer assembly or method of any of the preceding embodiments, wherein the hydrogen-based fluid stream has a composition of at least 90 vol. % hydrogen.
Embodiment 4: The fluid transfer assembly or method of any of the preceding embodiments, wherein the lubricant is an oil-based lubricant.
Embodiment 5: The fluid transfer assembly or method of any of the preceding embodiments, wherein the Venturi lubricant injector injects lubricant at a flowrate of at least 1 mL lubricant/hr.
Embodiment 6: The fluid transfer assembly or method of any of the preceding embodiments, wherein the hydrogen-based fluid stream at a flowrate of at least 240 L hydrogen/hr.
Embodiment 7: The fluid transfer assembly or method of any of the preceding embodiments, wherein the Venturi lubricant injector is fluidly connected to a lubricant reservoir.
Embodiment 8: The fluid transfer assembly or method of any of the preceding embodiments, wherein the fluid line comprises a split having a first fluid line section and a second fluid line section.
Embodiment 9: The fluid transfer assembly or method of embodiment 8, wherein the fluid line further comprises a joint re-joining the first fluid line section and the second fluid line section.
Embodiment 10: The fluid transfer assembly or method of any of the preceding embodiments, further comprising at least one valve operatively connected to the fluid line.
Embodiment 11: The fluid transfer assembly or method of embodiment 10, wherein the at least one valve comprises a gate valve, a check valve, or a butterfly valve.
Embodiment 12: The fluid transfer assembly or method of embodiment 10, wherein the at least one valve is located at the split.
Embodiment 13: The fluid transfer assembly or method of any one of embodiments 10-12, further comprising a solenoid located at the split and adapted to selectively move hydrogen-based fluid stream into one of the first fluid line section or the second fluid line section through selective actuation of the valve.
Embodiment 14: The fluid transfer assembly or method of embodiment 13, wherein the solenoid allows control of the valve by a user or by an automated system.
Embodiment 15: The fluid transfer assembly or method of any of the preceding embodiments, wherein the fluid line comprises tubing comprising a hydrogen stable material comprising a metal, a polymer, or a ceramic.
Embodiment 16: The fluid transfer assembly or method of any of the preceding embodiments, wherein the Venturi lubricant injector comprises a first cross-section and a second cross-section, wherein the second cross-section has a smaller diameter than the first cross-section.
Embodiment 17: The fluid transfer assembly or method of any of the preceding embodiments, wherein the Venturi lubricant injector comprises a body comprising a metal, a polymer, or a ceramic.
Embodiment 18: The fluid transfer assembly or method of any one of embodiments 10-17, wherein the at least one valve comprises a check valve disposed between the lubricant reservoir and the Venturi lubricant injector and adapted to selectively move lubricant from the lubricant reservoir into the Venturi lubricant injector.
Embodiment 19: The fluid transfer assembly or method of any of the preceding embodiments, wherein the lubricant reservoir comprises a vent adapted to expose the lubricant to a surrounding atmosphere.
Embodiment 20: The fluid transfer assembly or method of any of the preceding embodiments, wherein the Venturi lubricant injector maintains an internal pressure of at least 50 psi.
Embodiment 21: The fluid transfer assembly or method of any of the preceding embodiments, wherein the Venturi lubricant injector has a length of not greater than 4 in.
Embodiment 22: The fluid transfer assembly or method of any of the preceding embodiments, wherein the Venturi lubricant injector has a diameter of not greater than 1.5 in.
Embodiment 23: The fluid transfer assembly or method of any of the preceding embodiments, wherein the fluid line has a length of 5 to 100 in.
Embodiment 24: The fluid transfer assembly or method of any of the preceding embodiments, wherein the fluid line has a diameter of 0.25 in to 5 in.
Embodiment 25: The fluid transfer assembly or method of any one of embodiments 7-24, wherein the lubricant reservoir has a volume of 6 oz to 128 oz.
Embodiment 26: A fluid transfer assembly comprising: a fluid line comprising a hydrogen-based fluid stream; and a Venturi lubricant injector fluidly connected to the fluid line and adapted to inject lubricant into the hydrogen-based fluid stream within the fluid line.
Embodiment 27: The fluid transfer assembly of embodiment 26, wherein the hydrogen-based fluid stream has a composition of at least 90 vol. % hydrogen.
Embodiment 28: The fluid transfer assembly of embodiment 26, wherein the lubricant is an oil-based lubricant.
Embodiment 29: The fluid transfer assembly of embodiment 26, wherein the Venturi lubricant injector is fluidly connected to a lubricant reservoir.
Embodiment 30: The fluid transfer assembly of embodiment 26, wherein the fluid line comprises a split having a first fluid line section and a second fluid line section.
Embodiment 31: The fluid transfer assembly of embodiment 30, wherein the fluid line further comprises a joint re-joining the first fluid line section and the second fluid line section.
Embodiment 32: The fluid transfer assembly of embodiment 26, further comprising at least one valve operatively connected to the fluid line.
Embodiment 33: The fluid transfer assembly of embodiment 32, wherein the at least one valve comprises a gate valve, a check valve, or a butterfly valve.
Embodiment 34: The fluid transfer assembly of embodiment 32, wherein the at least one valve is located at the split.
Embodiment 35: The fluid transfer assembly of embodiment 32, further comprising a solenoid located at the split and adapted to selectively move hydrogen-based fluid stream into one of the first fluid line section or the second fluid line section through selective actuation of the valve.
Embodiment 36: The fluid transfer assembly of embodiment 35, wherein the solenoid allows control of the valve by a user or by an automated system.
Embodiment 37: The fluid transfer assembly of embodiment 26, wherein the fluid line comprises tubing comprising a hydrogen stable material comprising a metal, a polymer, or a ceramic.
Embodiment 38: The fluid transfer assembly of embodiment 26, wherein the Venturi lubricant injector comprises a first cross-section and a second cross-section, wherein the second cross-section has a smaller diameter than the first cross-section.
Embodiment 39: The fluid transfer assembly of embodiment 26, wherein the Venturi lubricant injector comprises a body comprising a metal, a polymer, or a ceramic.
Embodiment 40: The fluid transfer assembly of embodiment 32, wherein the at least one valve comprises a check valve disposed between the lubricant reservoir and the Venturi lubricant injector and adapted to selectively move lubricant from the lubricant reservoir into the Venturi lubricant injector.
Embodiment 41: The fluid transfer assembly of embodiment 26, wherein the lubricant reservoir comprises a vent adapted to expose the lubricant to a surrounding atmosphere.
Embodiment 42: The fluid transfer assembly of embodiment 26, wherein the Venturi lubricant injector maintains an internal pressure of at least 50 psi.
Embodiment 43: A method of modifying fluid comprising: providing a fluid line; flowing hydrogen-based fluid through the fluid line; providing a Venturi lubricant injector comprising a lubricant and fluidly connected to the fluid line; injecting the lubricant from the Venturi lubricant injector into the hydrogen-based fluid stream within the fluid line.
Embodiment 44: The method of embodiment 43, wherein the Venturi lubricant injector injects fluid at a flowrate of at least 1 mL lubricant/hr.
Embodiment 45: The method of embodiment 43, wherein the hydrogen-based fluid streams at a flowrate of at least 240.96 L hydrogen/hr.
Embodiment 46: A vehicular propulsion system comprising the lubricant system of embodiment 1.
Embodiment 47: The vehicular propulsion system of embodiment 46, further comprising a hydrogen fuel system.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

Note that not all of the activities described above in the general description or the examples are required, that a portion of a specific activity may not be required, and that one or more further activities may be performed in addition to those described. Still further, the order in which activities are listed are not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed:

1. A fluid transfer assembly comprising:
a fluid line comprising a hydrogen-based fluid stream; and
a Venturi lubricant injector fluidly connected to the fluid line and adapted to inject lubricant into the hydrogen-based fluid stream within the fluid line.

2. The fluid transfer assembly of claim 1, wherein the hydrogen-based fluid stream has a composition of at least 90 vol. % hydrogen.

3. The fluid transfer assembly of claim 1, wherein the lubricant is an oil-based lubricant.

4. The fluid transfer assembly of claim 1, wherein the Venturi lubricant injector is fluidly connected to a lubricant reservoir.

5. The fluid transfer assembly of claim 1, wherein the fluid line comprises a split having a first fluid line section and a second fluid line section.

6. The fluid transfer assembly of claim 5, wherein the fluid line further comprises a joint re-joining the first fluid line section and the second fluid line section.

7. The fluid transfer assembly of claim 1, further comprising at least one valve operatively connected to the fluid line.

8. The fluid transfer assembly of claim 7, wherein the at least one valve comprises a gate valve, a check valve, or a butterfly valve.

9. The fluid transfer assembly of claim 7, wherein the at least one valve is located at the split.

10. The fluid transfer assembly of claim 7, further comprising a solenoid located at the split and adapted to selectively move hydrogen-based fluid stream into one of the first fluid line section or the second fluid line section through selective actuation of the valve.

11. The fluid transfer assembly of claim 10, wherein the solenoid allows control of the valve by a user or by an automated system.

12. The fluid transfer assembly of claim 1, wherein the fluid line comprises tubing comprising a hydrogen stable material comprising a metal, a polymer, or a ceramic.

13. The fluid transfer assembly of claim 1, wherein the Venturi lubricant injector comprises a first cross-section and a second cross-section, wherein the second cross-section has a smaller diameter than the first cross-section.

14. The fluid transfer assembly of claim 7, wherein the at least one valve comprises a check valve disposed between the lubricant reservoir and the Venturi lubricant injector and adapted to selectively move lubricant from the lubricant reservoir into the Venturi lubricant injector.

15. The fluid transfer assembly of claim 1, wherein the Venturi lubricant injector maintains an internal pressure of at least 50 psi.

16. A method of modifying fluid comprising:
providing a fluid line;
flowing hydrogen-based fluid through the fluid line;
providing a Venturi lubricant injector comprising a lubricant and fluidly connected to the fluid line; and
injecting the lubricant from the Venturi lubricant injector into the hydrogen-based fluid stream within the fluid line.

17. The method of claim 16, wherein the Venturi lubricant injector injects fluid at a flowrate of at least 1 mL lubricant/hr.

18. The method of claim 16, wherein the hydrogen-based fluid streams at a flowrate of at least 240.96 L hydrogen/hr.

19. A vehicular propulsion system comprising the lubricant system of claim 1.

20. The vehicular propulsion system of claim 19, further comprising a hydrogen fuel system.
